(19) United States
(12) Patent Application Publication
(10) Pub. No.: US 2014/0324589 A1
(43) Pub. Date: Oct. 30, 2014

(54) Quick Response Code System

(71) Applicant: Barry Pacey, Crossgates (GB)

(72) Inventor: Barry Pacey, Crossgates (GB)

(21) Appl. No.: 14/010,597

(22) Filed: Aug. 27, 2013

(30) Foreign Application Priority Data
Apr. 24, 2013 (GB) 1307380.4

(51) Int. Cl. G06Q 30/02

(52) U.S. Cl. CPC G06Q 30/0261
USPC 705/14.58

(57) ABSTRACT

A communications method for directing users to a set of traveller services associated with a first localised geographical area, said method comprising:
providing a quick response code at a first geographical location;
reading said quick response code using a mobile telecommunications device capable of connecting with a mobile telecommunications network;
linking said mobile telecommunications device to a remote server computer using a uniform resource locator (URL);
said remote server computer selecting data corresponding to said uniform resource locator, said data comprising data specific to said set of traveller services;
wherein said traveller services are located at one or more second locations remote from said first location; and
sending said traveller service data to said mobile telecommunications device.

### FIELD OF THE INVENTION

The present invention relates to a quick response code system.

### BACKGROUND OF THE INVENTION

Highway rest areas were developed to provide the traveller with a means of relieving fatigue through a brief stay at a pleasant and relaxing area. In the United States, it is the duty of every state Department of Transport to provide the interstate traveller with basic services namely a safe place to stop, rest, use of toilet facilities, and to provide travel information. These rest areas should be provided at every 50-70 miles along a highway. If rest areas are not provided then there is a danger of drivers making shoulder stops. This is where vehicles are parked on the highway shoulder, posing a safety hazard to approaching motorists especially on high-speed roads.

In the United States, rest areas are typically non-commercial facilities that provide, at a minimum, parking and restrooms. Some may have information kiosks, vending machines, and picnic areas, but little else. They are maintained and funded by the Departments of Transportation of the state governments.

In the United States, there are four types of rest areas:

Welcome Centres

Safety Rest Areas

Rest Areas

Turnouts

There are laws that explicitly prohibit private retailers from occupying rest stops. A federal statute passed by Congress also prohibits states from allowing private businesses to occupy rest areas along Interstate Highways. The relevant clause of 23 United States Code §111 states:
“The State will not permit automotive service stations or other commercial establishments for serving motor vehicle users to be constructed or located on the rights-of-way of the Interstate System.”

The original reason for this clause was to protect innumerable small towns whose survival depended upon providing roadside services; because of it, private truck stops and exit businesses have blossomed into a $171 billion industry in the United States and contributed more than $22 billion in state and local taxes in 2010.

The standard practice is that private businesses buy up land near existing exits and build their own facilities to serve travellers. Such facilities often have tall signs that can be seen from several miles away (so that travellers have adequate time to make a decision). In turn, it is somewhat harder to visit such private facilities compared to a rest stop, because one has to first exit the freeway and navigate through several intersections to reach a desired business's parking lot.

Special blue signs indicating gas, food, lodging, camping and attractions at an exit can be found on most freeways in North America. Private businesses are permitted to add their logos to these signs by paying the government a fee—but space is very limited.

Attempts to remove the federal ban on privatized rest areas have been generally unsuccessful, due to resistance from existing businesses that have already made enormous capital investments in their existing locations.

In 2003, President George W. Bush's federal highway funding reauthorization bill contained a clause allowing states to start experimenting with privatized rest areas on Interstate highways. The clause was fiercely resisted by the National Association of Truck Stop Owners (NATSO), which argued that allowing such rest areas would shift revenue to state governments (in the form of lease payments) that would have gone to local governments (in the form of property and sales taxes). NATSO also argued that by destroying private commercial truck stops, the bill would result in an epidemic of drowsy truck drivers, since such stops currently provide about 90% of the parking spaces used by American truck drivers while in transit. This also threatened more than 97,000 businesses nationwide and jeopardized 2.2 million jobs.

In May 2012 the US Senate resoundingly rejected an amendment seeking to commercialize rest areas. However, without advertising, there is no way that people can connect with things they want and help they need.

According to a Washington State of Department of Transportation Survey in 2009:
49% of travellers don't have advanced reservations or tight itineraries
43% said they would be likely to change plans based on travel information available in rest areas
5% said that one of the reasons they stopped at the rest area was for travel information (5% of 52 million is 2,600,000)
There has been a 100% increase in rest area usage over the last 5 years

In some states, information kiosks provide the public with traveller and local information. This can include maps of the area, local history and tourist routes. Initial costs of erecting kiosks can be high and the management, production and placement of ads and maintenance is also a cost issue.

Facilities already available at rest stops include Wi-Fi and internet access on mobile telecommunications devices available through Wi-Fi or through mobile phone communications network connections. However, due to lack of subscription, Wi-Fi services are being discontinued at rest areas in some individual states.

There are online services such as Google Earth®. However, using internet based screen services whilst driving is dangerous, and in some cases illegal.

There are also a number of satellite navigation devices and mobile phone mapping apps that tell the traveller they are approaching restaurants, gas stations, hotels etc.

These ‘tags’ are limited due the available space on the screen.

There biggest drawback is the danger it puts the driver in when they try to access the information whilst driving on a high speed road. These tags only pop up when the vehicle is close to addresses and exiting the interstate at the last minute can be extremely dangerous.

Despite the advent of the internet, and facilities such as Google Earth®, travellers still have problems in finding fuel, accommodation, food and other services when driving along interstate highways. Finding a service involves leaving the highway, and getting back onto the highway can often be difficult and non-obvious to the traveller. There is also a risk of missing an exit on the highway, in which case it could be another 50 miles or so before there is another exit.

There is therefore a need to provide an improved communications network for enabling travellers to locate services adjacent interstate highways.

### SUMMARY OF THE INVENTION

According to a first aspect of the present invention, there is provided a communications method for directing users to a set of traveller services associated with a first localised geographical area, said method comprising:

providing a quick response code at a first geographical location;

reading said quick response code using a mobile telecommunications device capable of connecting with a mobile telecommunications network;

linking said mobile telecommunications device to a remote server computer using a uniform resource locator (URL);

said remote server computer selecting data corresponding to said uniform resource locator, said data comprising data specific to said set of traveller services;

wherein said traveller services are located at one or more second locations remote from said first location; and

sending said traveller service data to said mobile telecommunications device.

According to a second aspect of the present invention, there is provided an apparatus for assigning services to a quick response code marker over a mobile telephone communications network, said apparatus comprising:

means for receiving a request associated with said quick response code located at a first geographical location;

means for storing a set of data describing a plurality of services provided at a set of second geographical locations associated with said first geographical location;

means for associating said set of data describing a plurality of different services with said request; and

means for sending said data describing a plurality of different services over said mobile phone communications network to a sender of said request.

According to a third aspect of the present invention, there is provided a computer platform configured for:

receiving a request associated with said quick response code located at a first geographical location;

storing a set of data describing a plurality of services provided at a set of second geographical locations associated with said first geographical location;

associating said set of data describing a plurality of different services with said request; and

sending said data describing a plurality of different services over said mobile phone communications network to a sender of said request.

According to a fourth aspect of the present invention, there is provided a computer program control instructions controlling a computer platform for configured for:

reading a quick response code to find a uniform resource locator, wherein said uniform resource locator is uniquely associated with said quick response code;

connecting a mobile communications device to an address specified in said uniform resource locator;

selecting a set of data corresponding to said uniform resource locator; and

sending said selected set of data to said mobile communications device.

According to a fifth aspect of the present invention, there is provided a computer platform apparatus configured for communicating with a mobile telecommunications device, to provide data specific to a set of services associated with a first geographical location at which said mobile communications device is located said services being located at a set of second geographical locations, said apparatus comprising:

a central processing unit;

at least one memory;

at least one communications interface;

wherein said computer platform apparatus is configured for:

receiving a uniform resource locator corresponding to a quick response code data;

identifying said uniform resource locator;

identifying data assigned to said uniform resource locator, said data describing a said set of services located at a set of second geographical locations; and

sending said service data to said mobile communications device.

According to a sixth aspect of the present invention, there is provided a method of using a quick response (QR) code on printed matter to advertise a uniform resource locator (URL) said method characterised by:

receiving a said uniform resource locator;

in response to said received uniform resource locator, reading a database of goods and services geographically relevant to a physical site of said quick response code location.

Other aspects are as set out in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a communications apparatus for communicating between a user at a first location, and one or a plurality of services at a set of second locations near the user's location;

FIG. 2 illustrates internet connectivity between a user device, a communications service computer, and several local traveller service computers;

FIG. 3 illustrates a logical relationship between a user at a first location, a communications service, and a plurality of traveller services;

FIG. 4 illustrates schematically a map showing a rest area at a first location A, and several traveller services accessible from a highway junction, at a set of second locations B-F;

FIG. 5 illustrates schematically in aerial view a welcome center type rest stop adjacent a highway;

FIG. 6 illustrates schematically in aerial view a safety rest area type rest stop adjacent a highway;

FIG. 7 illustrates schematically in aerial view a rest area type rest stop adjacent a highway;

FIG. 8 illustrates schematically in aerial view a turnout type rest stop adjacent a highway;

FIG. 9 illustrates schematically a quick response code marker suitable for attachment to a flat surface such as a floor or wall;

FIG. 10 illustrates schematically the quick response code marker of FIG. 9, stuck to a floor area;

FIG. 11 illustrates schematically the quick response code marker of FIG. 9 mounted to a wall of a building;

FIG. 12 illustrates schematically a sequence of operation of a mobile telecommunications device according to a specific method described herein;

FIG. 13 illustrates schematically process steps carried out by the user mobile telecommunications device of FIG. 12 herein;

FIG. 14 illustrates schematically components of a host server computer according to a specific embodiment described herein;

FIG. 15 illustrates schematically a set of data types stored in the host server computer of FIG. 14 herein;

FIG. 16 illustrates schematically a first data display on a user's mobile telecommunication device according to a specific method herein;

FIG. 17 illustrates schematically a second data display on a user's mobile telecommunication device according to a specific method herein;

FIG. 18 illustrates schematically a third data display on a user's mobile telecommunication device according to a specific method herein;

FIG. 19 illustrates schematically a fourth data display on a user's mobile telecommunication device according to a specific method herein;

FIG. 20 illustrates schematically a fifth data display on a user's mobile telecommunication device according to a specific method herein;

FIG. 21 illustrates schematically a sixth data display on a user's mobile telecommunication device according to a specific method herein;

FIG. 22 illustrates schematically a seventh data display on a user's mobile telecommunication device according to a specific method herein;

FIG. 23 illustrates schematically an eighth data display on a user's mobile telecommunication device according to a specific method herein;

FIG. 24 illustrates schematically a ninth data display on a user's mobile telecommunication device according to a specific method herein;

FIG. 25 illustrates schematically a tenth data display on a user's mobile telecommunication device according to a specific method herein;

FIG. 26 illustrates schematically process steps carried out by the host server computer for providing data a remote user mobile telecommunications device;

FIG. 27 illustrates schematically process steps carried out by the host server computer for sending meta data of an individual service provider to a user's mobile telecommunications device;

FIG. 28 illustrates schematically process steps carried out by the host computer for updating a service provider user profile within the host computer server's data storage device according to a specific method herein;

FIG. 29 illustrates schematically process steps carried out overall to implement a method of providing a set of users with a set of traveller data; and

FIG. 30 illustrates schematically process steps carried out by a specific embodiment computer platform, to deliver traveler data to a set of users located at a first geographical location with traveler service data referring to services provided at a second location, but associated with the first location.

### DETAILED DESCRIPTION OF THE EMBODIMENTS

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

Specific embodiments and methods described herein aim to provide a menu based service available to travellers, using a quick response code marker at a geographical location, to access a uniform resource locator which links to a webpage, to display data describing one or a plurality of services at a geographical locations close to or most readily accessible from a geographical location at which the quick response code is located. The services are specific to the geographical location at which the quick response code is positioned. Typically, the quick response code marker will be positioned at a highway welcome center, safety rest area, rest area or turnout.

Each separate welcome center, safety rest area, rest area or turnout is provided with a specific unique quick response code marker which applies only to that location, and which links to the services surrounding that welcome center, safety rest area, rest area or turnout, and which are accessible by turning off a highway typically at the next junction. The quick response code, and the uniform resource locator of themselves do not contain any geographical data, but the quick response code is linked to a particular geographical location by virtue of being physically permanently attached or positioned at that geographical location. Hence, a geographical location of a highway welcome area, safety rest area, rest area or turnout is associated with a specific unique quick response code, which in turn is associated with a specific unique uniform resource locator (URL). The specific uniform resource locator is associated with a specific set of data describing traveller services available in a set of second geographical areas surrounding and accessible from the first geographical area.

Particularly, although not exclusively, the embodiments concern a quick response code system which matches a quick response code marker physically located at a first geographical location with a set of services each provided at a set of geographical locations.

Overview of the Concept

The present disclosed concept uses quick response codes which are a data matrix that carries up to several hundred times the amount of data carried by ordinary bar codes.

There are two main things that a user of the system needs:
a. A mobile phone with a camera and internet connectivity (minimum 3G)
b. A quick response code reader app. Most new smart phones have a quick response code reader already installed or these can be easily downloaded free of charge from the phone app store.

The quick response codes are printed on a floor graphic or on a wall poster.

The travellers scan the quick response codes with their phones and this will then connect them to a specific ‘local’ uniform resource locator web page. This page includes a menu of services offering the traveller local restaurants, lodging, gas stations, tourist information, weather and road conditions etc. The user can also link into all the other Interstate Highways exit ‘HUB’ pages.

The main menu is subdivided into separate ads. These ads link to the advertisers their own dedicated web page which they amend and upload at any time they wish for the purpose of changing offers, prices, discount offers, etc.

Other links will be for weather reports, road and tourist information.

The system may allow the traveller to access considerably more information than any other type of advertising medium (leaflets, billboards, kiosk posters, electronic information screens) and complies with all the federal and state laws.

Each rest area will have its own unique uniform resource locator page and advertisers can choose which rest area sites they wish to be linked to.

This model does not limit the amount of ads which can be listed. New advertisers can be included at any time, or expired ones can be withdrawn, without the need to change the quick response codes. Each installed quick response codes can remain installed for as long as it is serviceable.

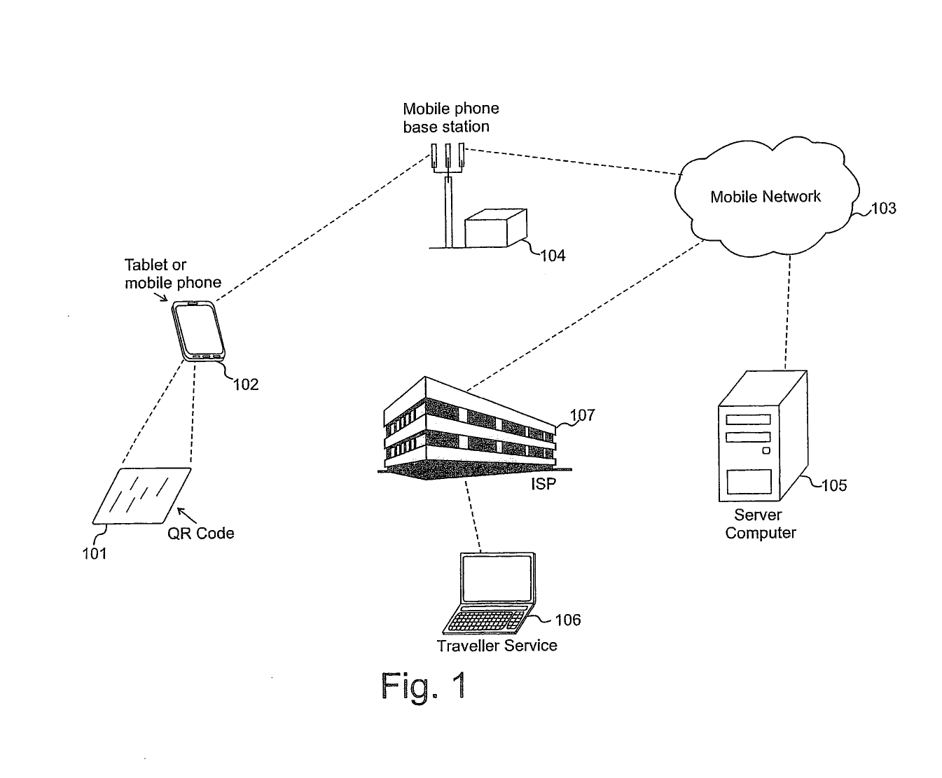

Referring to FIG. 1 herein, there is illustrated schematically a communications apparatus for communicating between a plurality of services and a user according to a specific embodiment.

The apparatus comprises a quick response code marking 101; a hand held mobile telecommunications device 102, for example a third or fourth generation phone, laptop or tablet; a mobile telecommunications network 103, comprising a conventional backbone network including a plurality of interconnected mobile phone base stations 104, and optionally, a conventional public service telephone network (PSTN); connected to the mobile network, a server host computer 105; and one or a plurality of traveller service provider computers 106, which may be connected to the mobile telecommunications network 104 by one or more internet service providers 107.

The quick response code 101 is physically located at a first geographical location, for example at a highway rest point, such as a welcome center, safety rest area, rest area or turnout area, and is stuck to the ground or displayed on a wall, post, or the like. Each separate highway rest point has its own unique quick response code which is specific to the location of that rest point.

The quick response code can be read by a conventional mobile phone or tablet type device which connects over the mobile communications network 103 to a remote host server computer 105. The server computer provides data over the mobile communications network to the mobile phone or tablet 102 to provide a menu displaying a plurality of traveller services which are located at a next highway turnout from the rest area.

For a pair of rest areas in opposite directions on a highway, for example one on a North bound carriageway and one on a South bound carriageway, each of these rest areas would have a separate unique quick response code marker.

The individual traveller services include facilities such as hotels, restaurants, filling stations, retail shops, camping areas, tourist attractions, automobile repair facilities/dealerships, breakdown services, coffee shops, truck stops and other services of use to travellers using main artery highways.

Individual traveller service providers may submit data describing their services to the data service provider operating the host computer, and that data is stored on the service provider server computer 105. Individual traveller service provider's websites can be linked through from the data provided to the user by the service provider computer 105, so that the user can establish in more detail the specific type of services provided, plus any discounts, special offers, or availability information which may be changed substantially in real time by the traveller service.

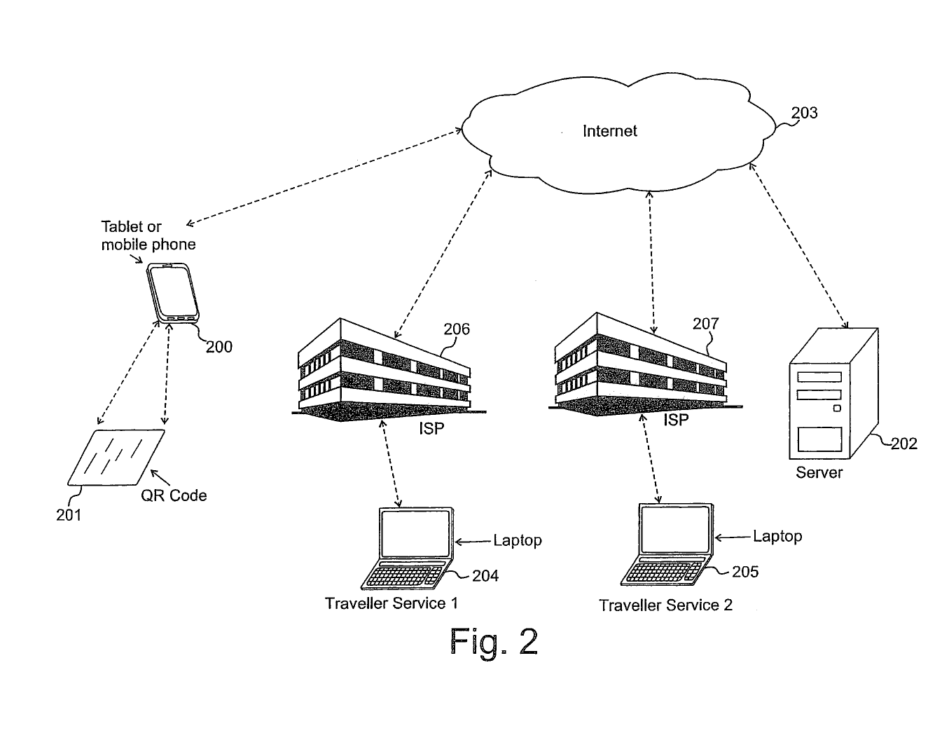

Referring to FIG. 2 herein, there is illustrated schematically connection of a user's handheld device 200 to a host server computer 202 over an internet network 203, and connection of individual service provider computers 204, 205 to the host computer.

The user's handheld mobile telecommunications device 200 is equipped with a camera device which takes a photo of a quick response code 201. The mobile telecommunications device 200 connects to remote host server 202 via the internet 203, using a mobile telecommunications network as the underlying carrier. The host computer 202 provides data describing a set of services available at a set of second geographical locations, nearby to the geographical location of the quick response code, with data describing each of those services. The host computer 202 also provides uniform resource locator link data to the mobile telecommunications device, enabling the mobile telecommunications device to connect with one or a plurality of traveller service provider websites on their own servers 206, 207 directly. Each service host computer may be accessed by a user, using a remote device such as a laptop computer 204, 205 or a personal computer, for updating and maintaining the electronic data describing the services provided by the traveller services.

Traveller Service Accounts

Each traveller service may have an account on the host computer 202, which gives them different levels of permissions to add or modify data describing their traveller service. For example, a basic account may provide just location information of the traveller service and a brief description of the services and directions to the service from the location of the quick response code, whilst a higher level account type may provide the facility to link through to a traveller service provider's own website, to deploy special offers or discounts, to provide availability information, for example room availability or parking place availability.

In general, each traveller service account will be linked to a set of data held on the host server 202 which is provided in response to a single unique quick response code provided at a single rest stop location, so that the user accessing the data service is presented only with pre-selected and filtered information specifically relevant to traveller services available at the next highway exit on from the location of the specific quick response code.

Each traveller service computer may access the local area service data specific to their account, corresponding to the quick response code on the host computer 202 directly over the internet, in order for the traveller service to update their particular details on the host computer.

Each unique quick response code embeds a unique uniform resource locator (URL) also known as a web address. In the best mode embodiment, each unique quick response code has a corresponding respective unique webpage, and on the webpage is displayed a list of all of the traveller service providers at locations nearest, that is, at the next highway turnout, to the location of the quick response code marker.

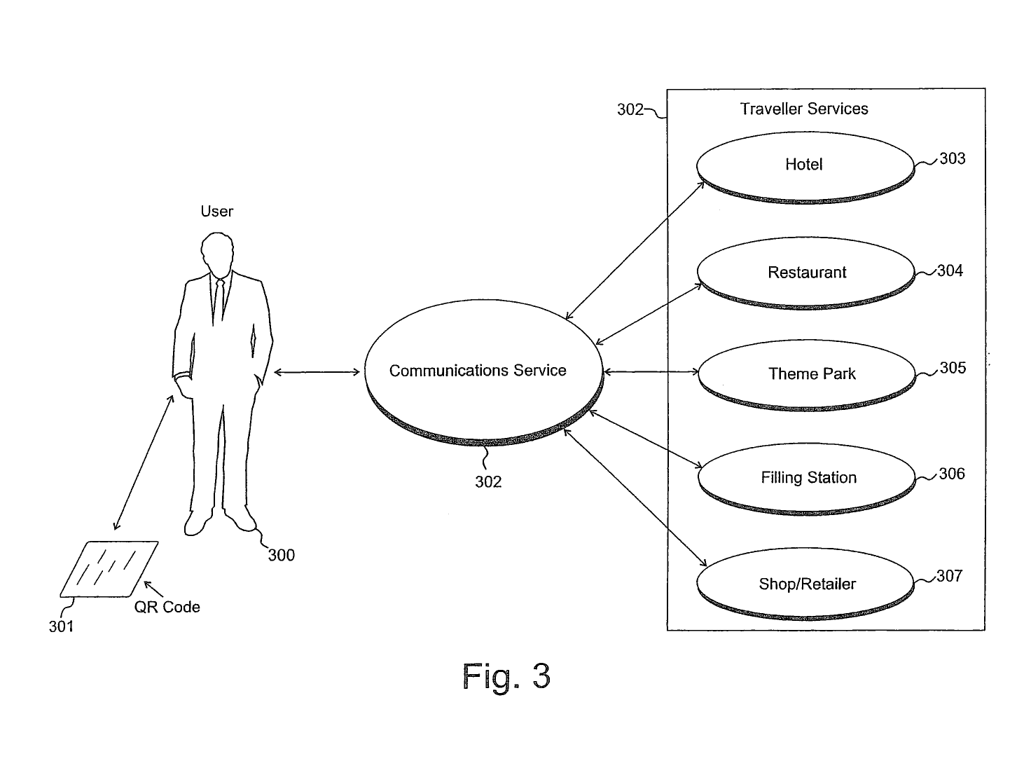

Referring to FIG. 3 herein, there is illustrated schematically a logical relationship between each of the entities within the system shown in FIG. 1 herein.

A user 300, equipped with their own known mobile telecommunications device, stands adjacent a quick response code marker 301, which can be either a ground attached marker, on a pavement, side walk or paved area, or can be a wall mounted marker in the form of a sticker or label. The user 300 reads the quick response code using their handheld device as is already known in the prior art. The quick response code directs the user's mobile telecommunications device to the host service provider 302. The host service provider 302 transmits data corresponding to a set of individual pre-selected traveller services 303-307 back to the user's mobile telecommunications device. A screen display on the mobile telecommunications device allows the user to select data relating to each one of the individual services 303-307, to check the type of services available, their cost, the availability, and other characteristics of the individual services. The individual services may comprise for example hotel or room services 303, restaurant services 304, local attractions such as theme parks or public events such as concerts, festivals or the like 305; petrol filling stations 306; shops or retailers 307, truck stops and the like.

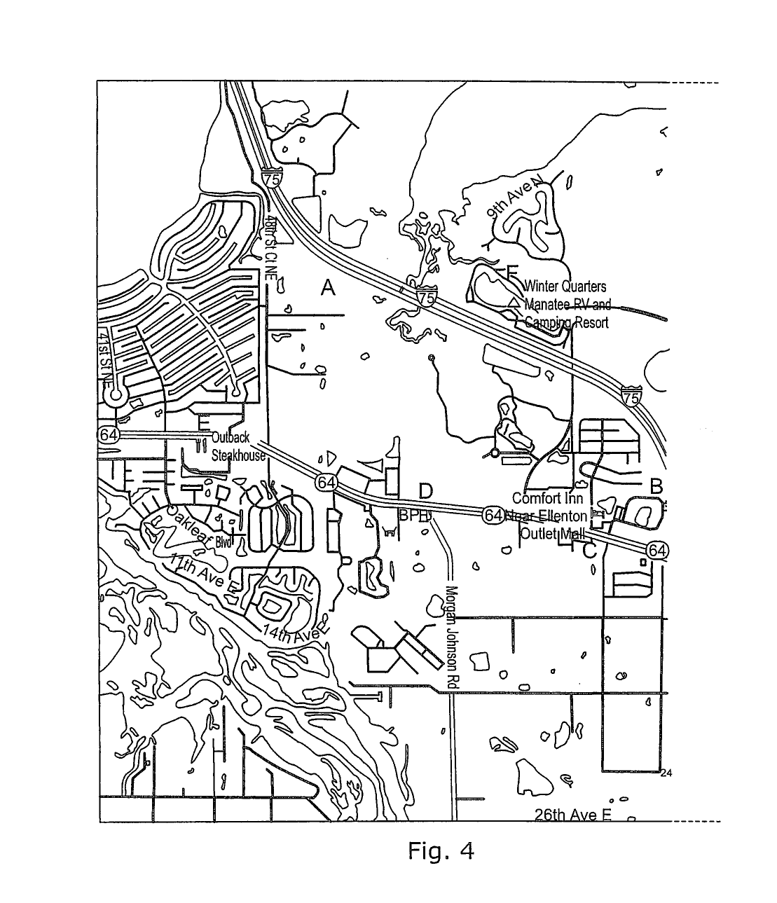

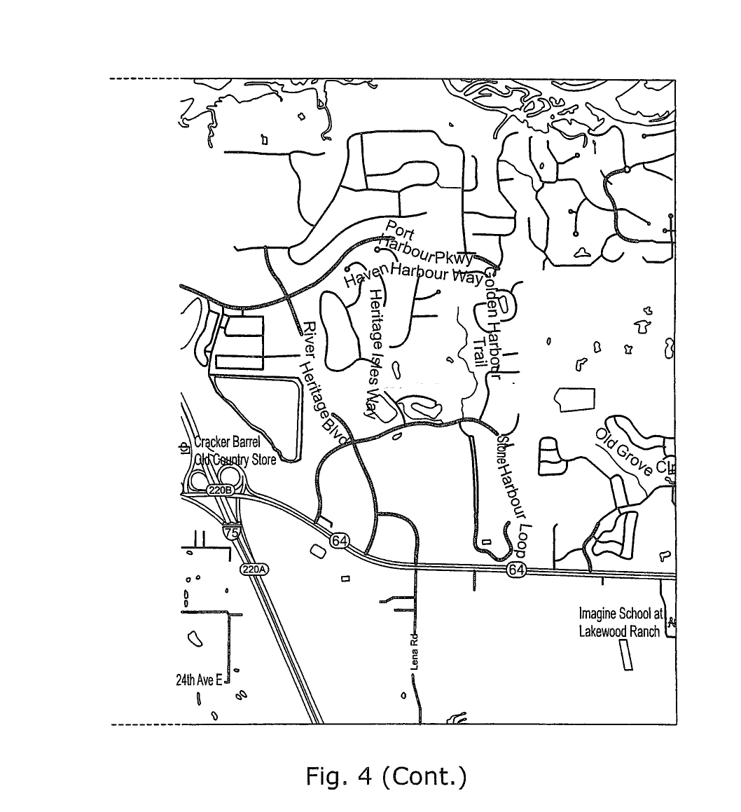

Referring to FIG. 4 herein, there is illustrated schematically a map showing an example of a quick response code location A, and a plurality of traveller service locations B-F, corresponding to the quick response code location A. In this example, on interstate highway 75 South bound direction, a quick response code marker is located at a rest area at location A. Travellers stopping at that rest area, at which no traveller services are provided other than basic Department of Transport services (toilet facilities, parking and picnic area), can scan a quick response code marker, using their mobile phone. The mobile phone links them through to a service provider computer as herein before described, which returns data corresponding to a uniform resource locator which displays on their hand held device a list of traveller services available at the next South bound intersection (Junction 220A). In this case, the individual traveller services B-F include a store, a hotel, a petrol service station, a restaurant, and a camping resort, each of which are located off Junction 220A.

The host service provider may also provide directions data giving directions to each of those service provider locations, as well as a link through to the individual websites of each of those service providers, and other information such as whether the services are open for use.

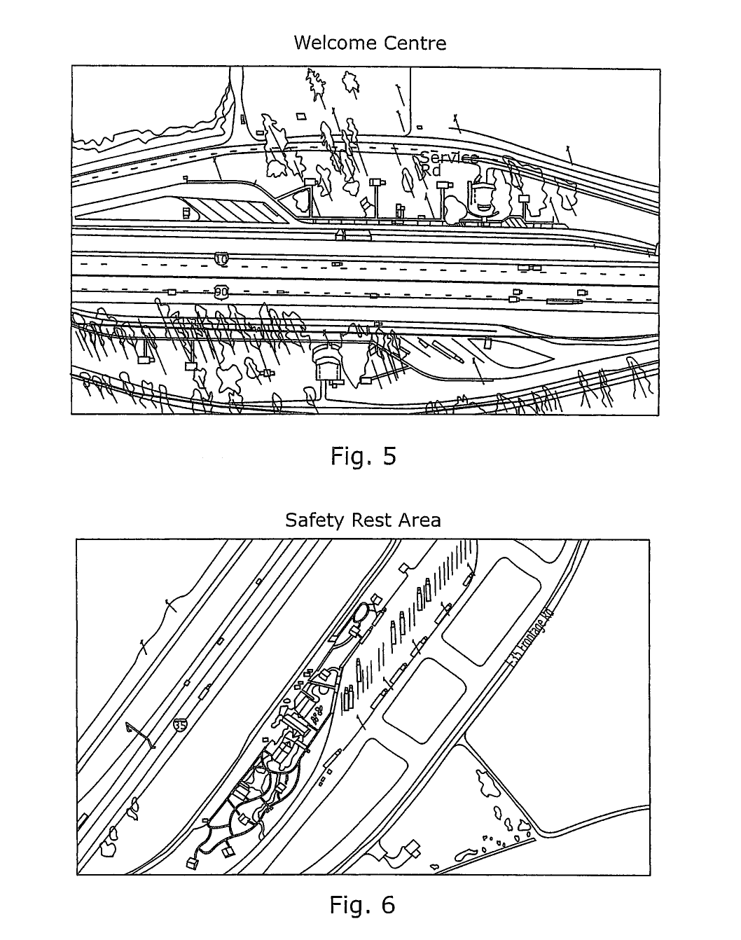

Referring to FIG. 5 herein, there is illustrated schematically in plan view, one example of a welcome center constructed adjacent a bi-directional interstate highway. A unique quick response code is assigned to the welcome center, which contains a uniform resource locator, which is assigned to a set of data describing traveller services at a set of second locations, accessible from the welcome center at a next highway exit.

Referring to FIG. 6 herein, there is illustrated schematically in plan view one example of a known safety rest area built adjacent an interstate highway. The safety rest area is assigned its own unique quick response code which links through to a set of traveller services at a set of second locations corresponding to the location of the safety rest area.

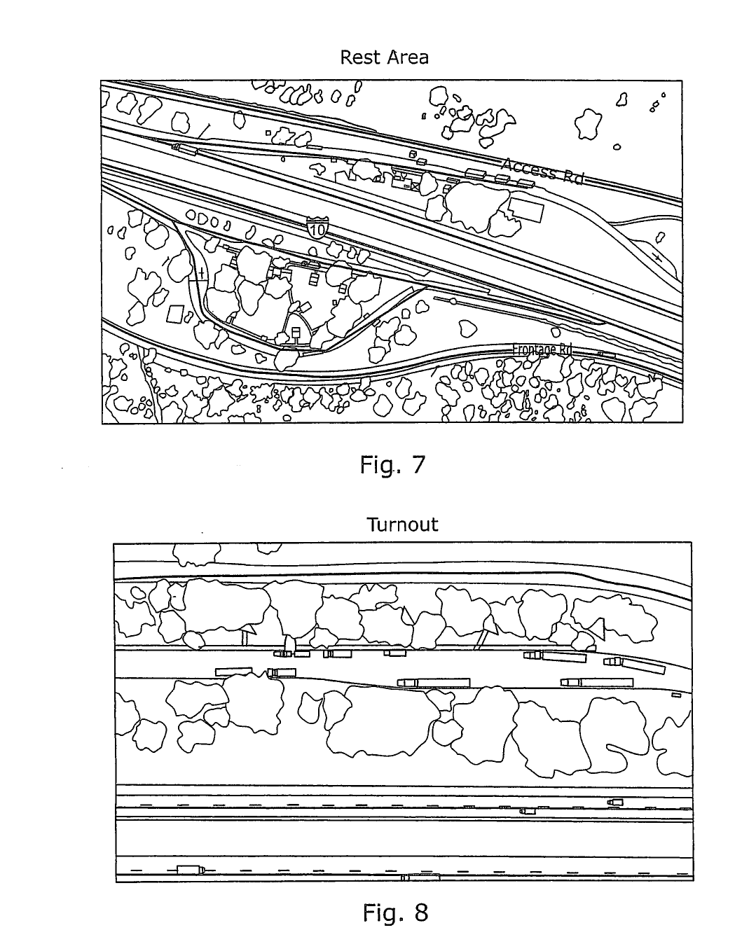

Referring to FIG. 7 herein, there is illustrated schematically in plan view one example of a conventional rest area constructed either side of an interstate highway. The rest area is provided with a quick response code marker physically attached and located at various positions at the rest area. Scanning the quick response code using a user's mobile telecommunications device links through to the host server of the host service provider and provides data displayed on the user's mobile telecommunications device describing a set of services which are nearby and accessible at the next highway junction from the rest area.

Referring to FIG. 8 herein, there is illustrated schematically in plan view, a conventional turnout, constructed adjacent an interstate highway. The turnout has its own unique quick response code marker, which links through to the host server to provide data of services located at a set of second locations, which are specific to the turnout.

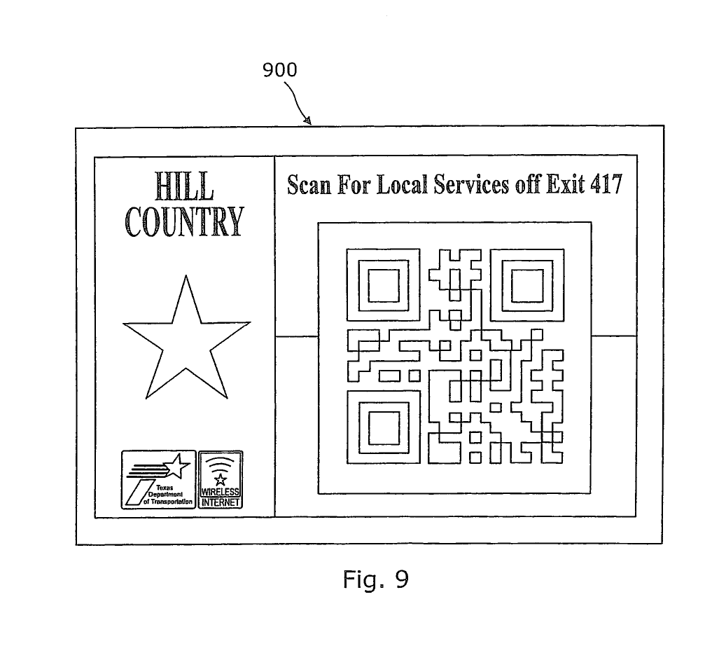

Referring to FIG. 9 herein, there is illustrated schematically one example of a quick response code marker, suitable for permanent attachment to a ground of floor area at a rest area or similar geographical location, and which may also be attached to an upright substantially vertical surface.

The printed quick response code mark 900 comprises part of a larger sign containing other information such as information describing a geographical location, in this case exit 417 of a highway, and place name Hill Country. In the best mode embodiment, the quick response code marker comprises a printed sheet of plastics material having an adhesive backing for permanently attaching the marker to a floor, wall or notice board.

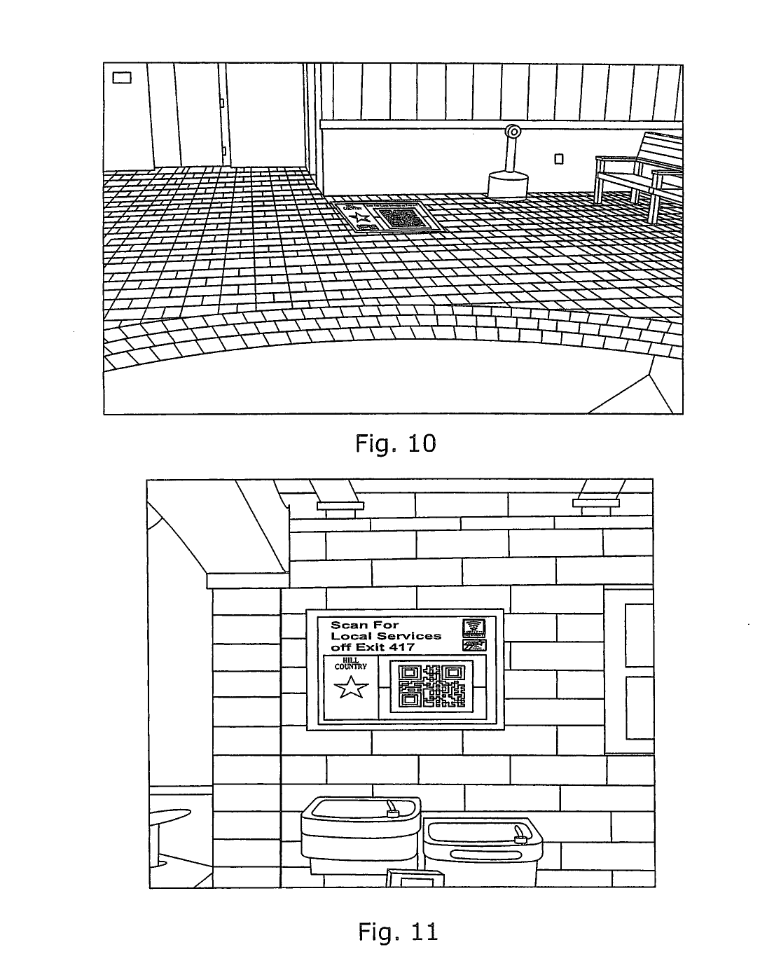

Referring to FIG. 10 herein, there is illustrated schematically one example of a quick response code marker adhered to the floor in a rest area. The quick response code marker has dimensions in the range 30 cm-50 cm×30 cm-50 cm, and is large enough to enable a user standing up holding their mobile phone at waist or chest height to scan the quick response code whilst standing adjacent to the marker.

Referring to FIG. 11 herein, there is illustrated one example of an installation of a quick response code marker positioned vertically on a wall at a rest area or welcome area.

User Sessions

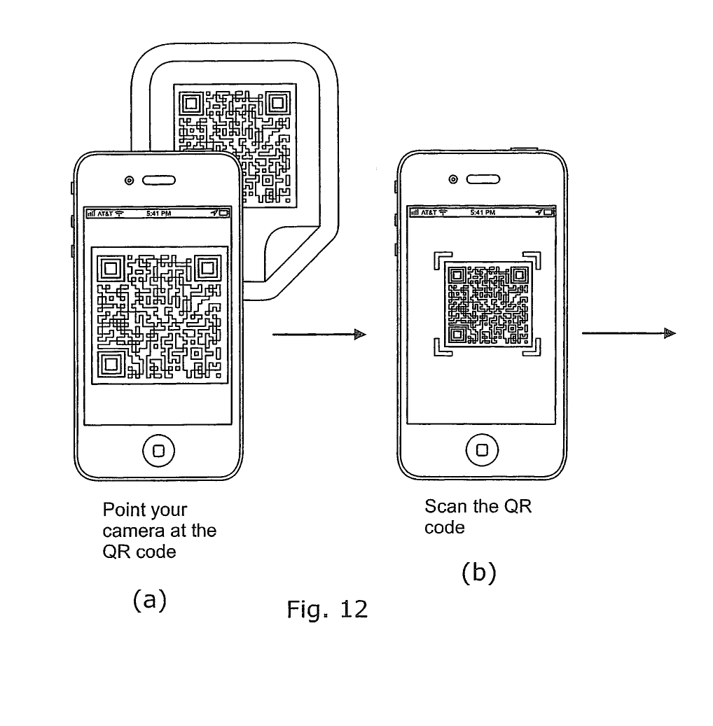

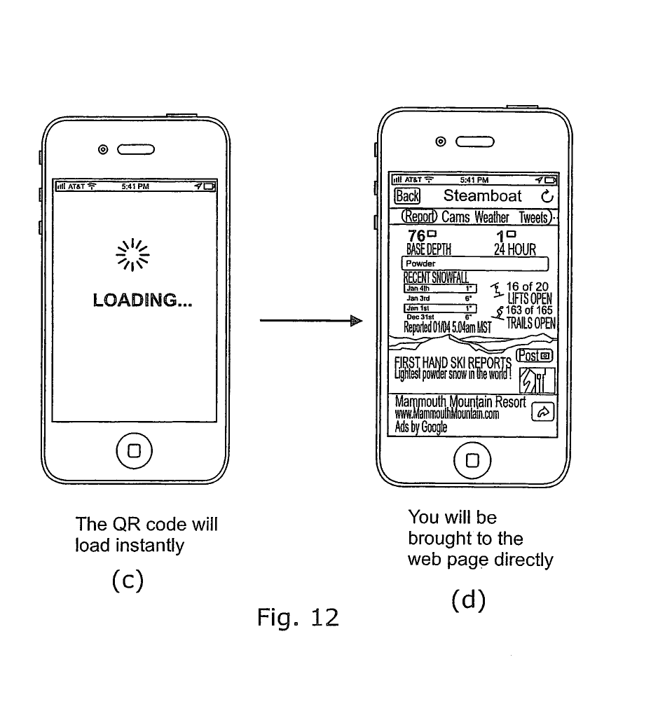

Referring to FIG. 12 herein, there is illustrated schematically a sequence of operation of a mobile telecommunications device for accessing traveller service data from a first geographical location.

Firstly, the user points the camera of the mobile telecommunications device at a quick response code on the floor or on a wall (a).

An application on the mobile telecommunications device scans the quick response code (b).

Thirdly, the mobile telecommunications device loads the quick response code, using the quick response code reading application (c) and communicates over the network with a uniform resource locator address specified in the quick response code.

Fourthly, the mobile telecommunications device receives and displays data retrieved from a remote host server computer, the data corresponding to one or a plurality of services which are accessible from a next highway turnout from the geographical location at which the quick response code is positioned.

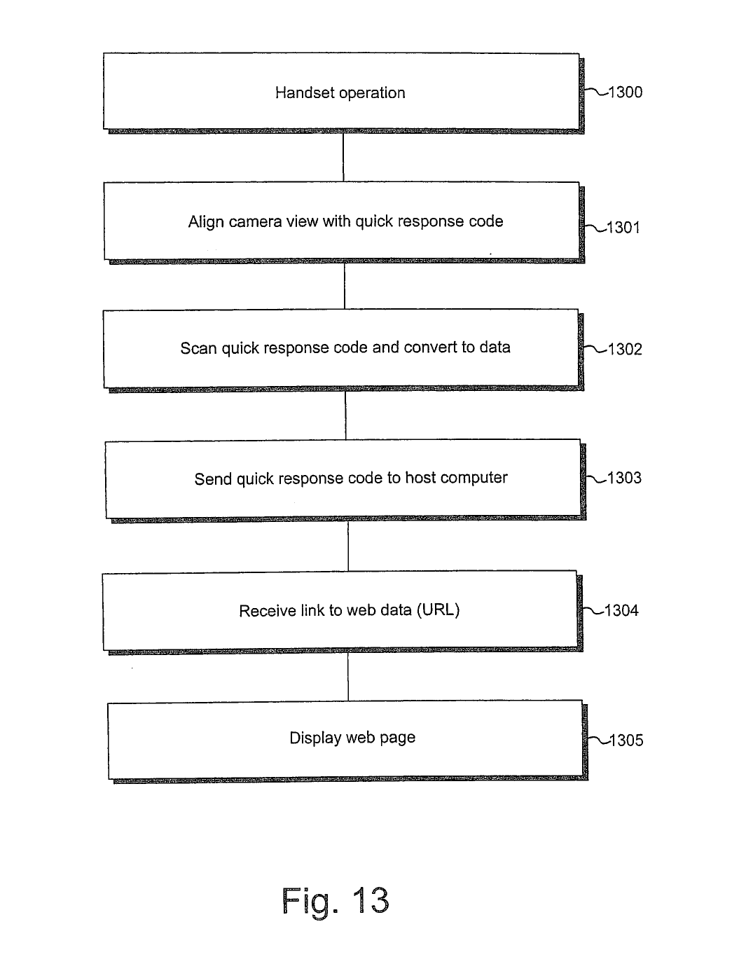

Referring to FIG. 13 herein, there are illustrated schematically process steps carried out by a mobile telecommunications device for accessing data describing traveller services at a location associated with a location of a quick response code. The mobile device is fitted with a quick response code reading application. Known quick response code reader applications including RedLaser or QR Droid or QR Code Scanner Pro.

At 1301, the user aligns the camera of the mobile telecommunications device with a quick response code marker.

At 1302, the user scans the quick response code into the mobile telecommunications device. The application in the mobile telecommunications device converts the quick response code to extract the uniform resource locator data.

At 1303, the mobile telecommunications device sends a request for data to the uniform resource locator address at a host computer over a mobile telecommunications network.

At 1304, the mobile telecommunications device receives a connection from the remote host computer linking the mobile telecommunications device to web data at a uniform resource locator address unique and specific to the particular quick response code which has been read.

At 1305, the mobile telecommunications device displays a webpage corresponding to the uniform resource locator, the webpage displaying data describing one or a plurality of services available in a geographical area associated with the geographical location at which the quick response code has been read. For example, where the quick response code has been read at a turnout area, the data displayed on the webpage will comprise data describing specific services positioned at a next interstate highway turnout junction immediately following the turnout at which the quick response code has been read.

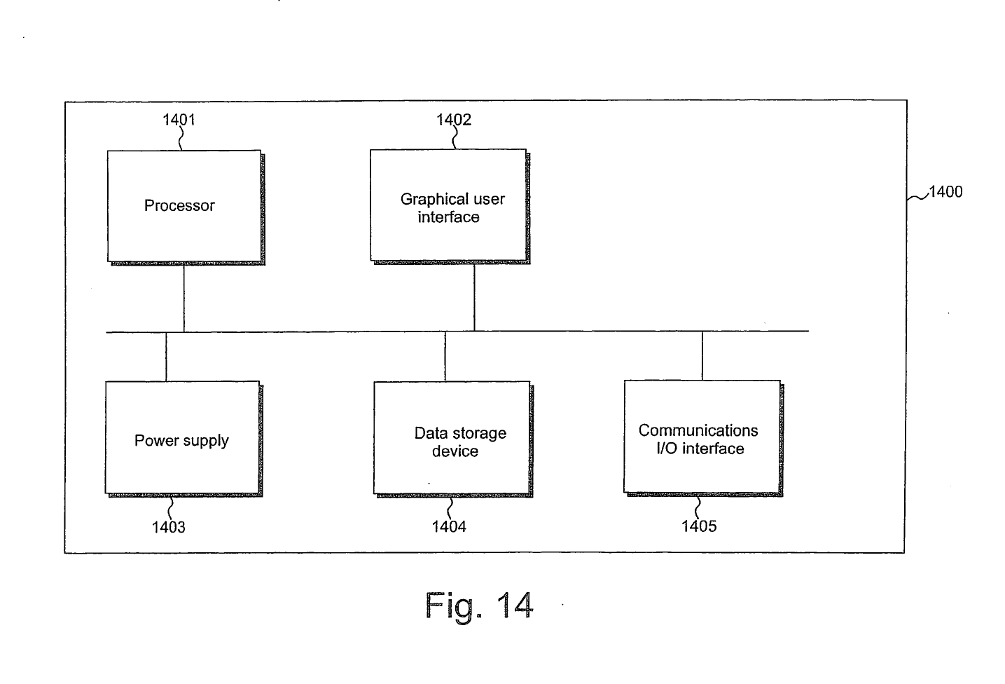

Referring to FIG. 14 herein, there is illustrated schematically components of a host server computer for providing a data service to a user mobile telecommunications device. The computer 1400 comprises a processor 1401; a graphical user interface 1402; a power supply 1403; a data storage device 1404; and a communications input/output interface for communicating over a mobile phone connection and/or via the internet with one or more remote mobile telecommunications devices, and one or more traveller service provider computers.

The data storage device 1404 stores data comprising a table listing:
A set of uniform resource locator codes;
For each uniform resource locator code, a plurality of sets of traveller service data;
Each set of traveller service data comprises data describing attributes of a particular traveller service;

Each traveller service is physically located at a geographical location in the vicinity of a particular rest stop area at a particular first geographical location, which is uniquely assigned to a specific uniform resource locator.

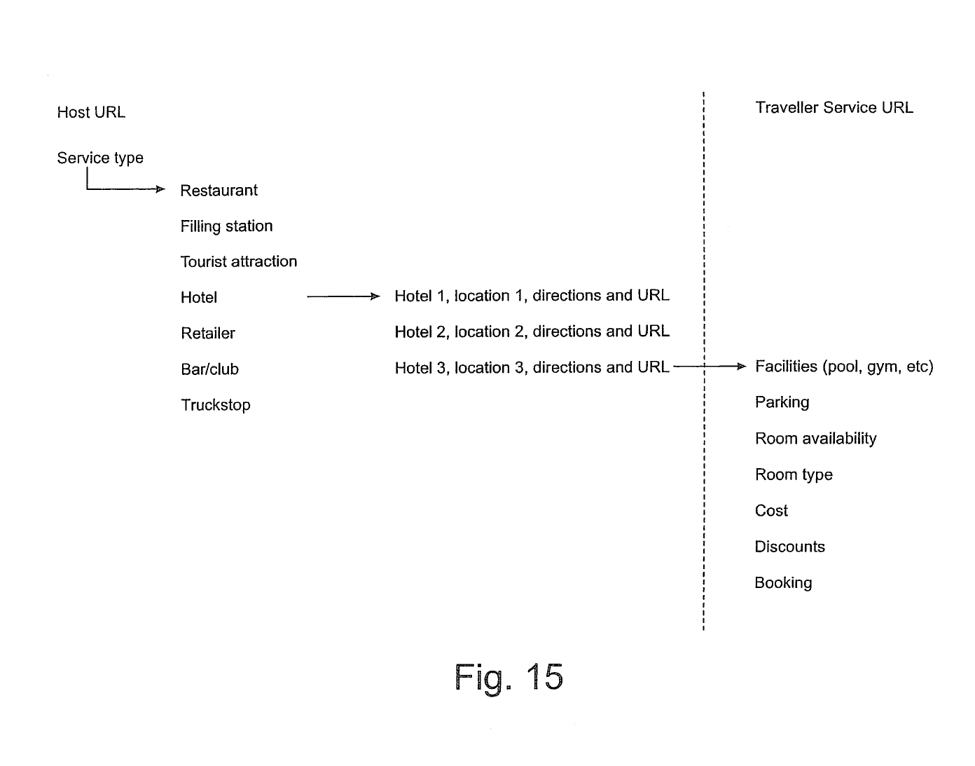

Referring to FIG. 15 herein, there is illustrated schematically data types provided in the memory of the host computer corresponding to data specific to a single first geographical location, and a corresponding respective uniform resource locator.

Each quick response code is associated with unique first geographical location, and a unique uniform resource locator, which has associated with it a specific set of traveller service data as shown in FIG. 15. For a single uniform resource locator, the data includes:
Service type data: this describes the type of service available, for example restaurant, filling station, tourist attraction, hotel, retailer, bar/club, truck stop or other service.
Individual service data: in the example shown, specific instances of different services of a particular type, in this case hotels are listed being hotel 1 provided at geographical location 1, hotel 2 provided at geographical location 2 and so on.
The specific service data may also include direction data, giving directions between the first geographical location at which the quick response code is located, and the location of the service.
Service data provided by a service provider uniform resource locator: this data includes data provided by the traveller service, which may be accessible via their own traveller service uniform resource locator. This data may include data describing the facilities, for example pool; gym; internet; Wi-Fi; parking availability; room availability; room type; cost; discounts; and booking information, in the case of a hotel service provider. In the case of other service provider types, the traveller service provider data will be specific to that particular type of service and that particular service provider's own business.

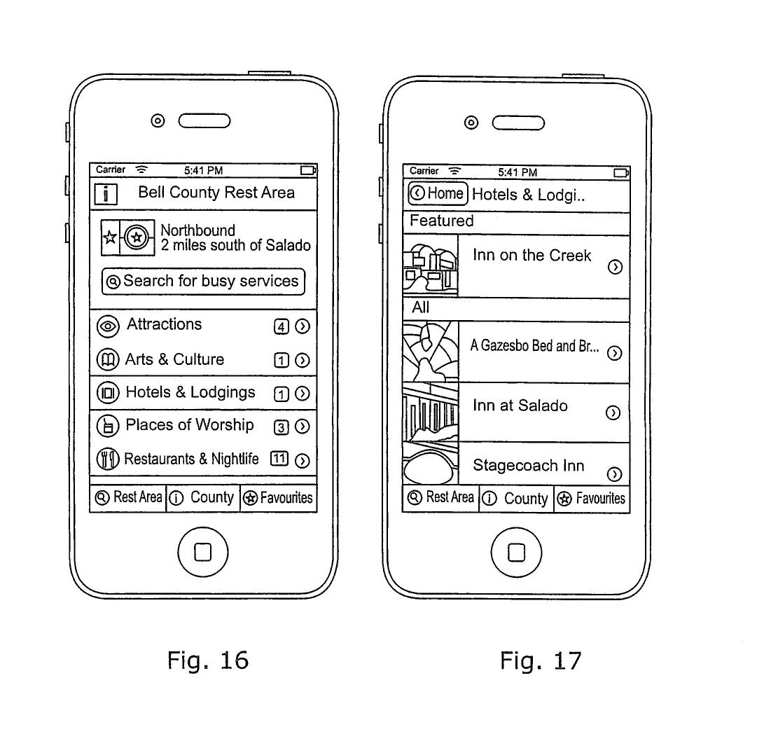

Referring to FIG. 16 herein, there is illustrated schematically an example of data received by a mobile telecommunications device and displayed on the device in response to a quick response code scanned by the mobile telecommunications device and a corresponding request sent to the remote server. FIG. 16 shows a page of data for a particular rest area at which a quick response code is located. Contained on the page is an entire drop down sub-menu of all the services which the traveller can access from the next highway junction from the rest area at which the quick response code is located.

Referring to FIG. 17 herein, there is illustrated a next stage menu, accessed by selecting one of the service types presented on the menu of FIG. 16 herein. By pressing the “Hotel and Lodgings” heading, the mobile telecommunications device interrogates the host computer over the mobile communications network/internet and downloads a sub-menu relating to all hotel and lodgings services assigned to the particular geographical location represented by the quick response code.

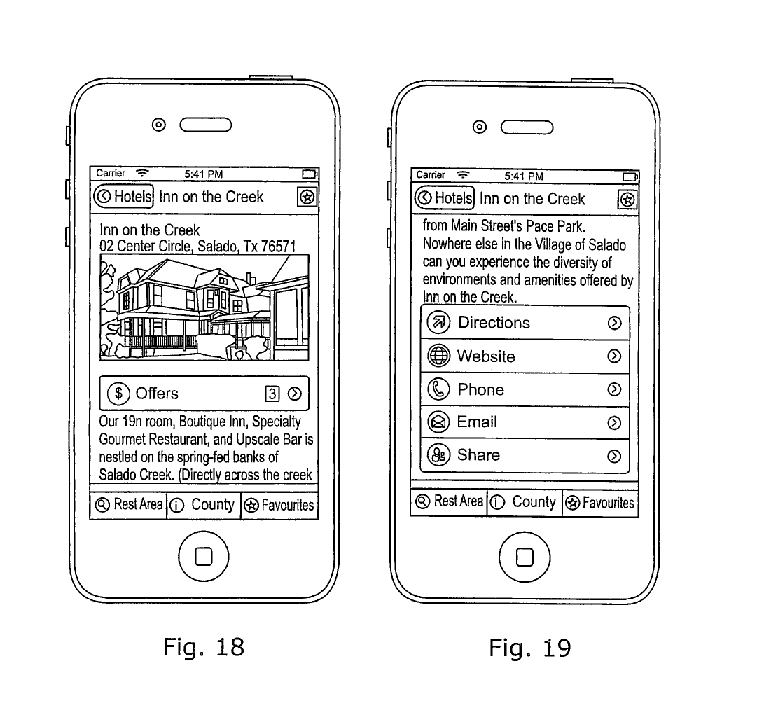

Referring to FIG. 18 herein, there is shown a particular selection of one of the service providers shown in the menu of FIG. 17 herein. At this level of menu, data describing a particular service provider is downloaded from the host server. This level of data includes items such as special offers available, room availability, general location and description of the service.

Referring to FIG. 19 herein, there is further useful data available to the user of the mobile telecommunications device, downloaded from the server computer including data describing directions, a website of the service, phone number, email or other contact details.

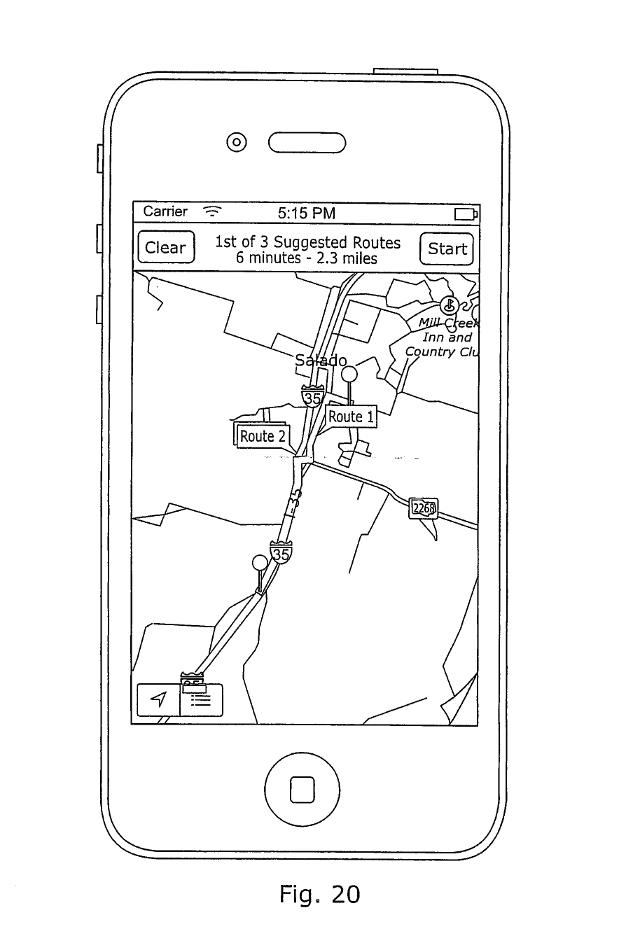

Referring to FIG. 20 herein, there is shown data describing a map, location and directions to the service selected in the menu of FIG. 19 herein. The location menu can also act as a SAT-NAV for spoken directions.

All of the data displayed in FIGS. 16 to 20 herein are provided from the database from the host computer server.

The user can also link through to a service providers own webpage, by following a uniform resource locator comprising data provided by that host which connects the mobile telecommunication device to the traveller service providers webpage.

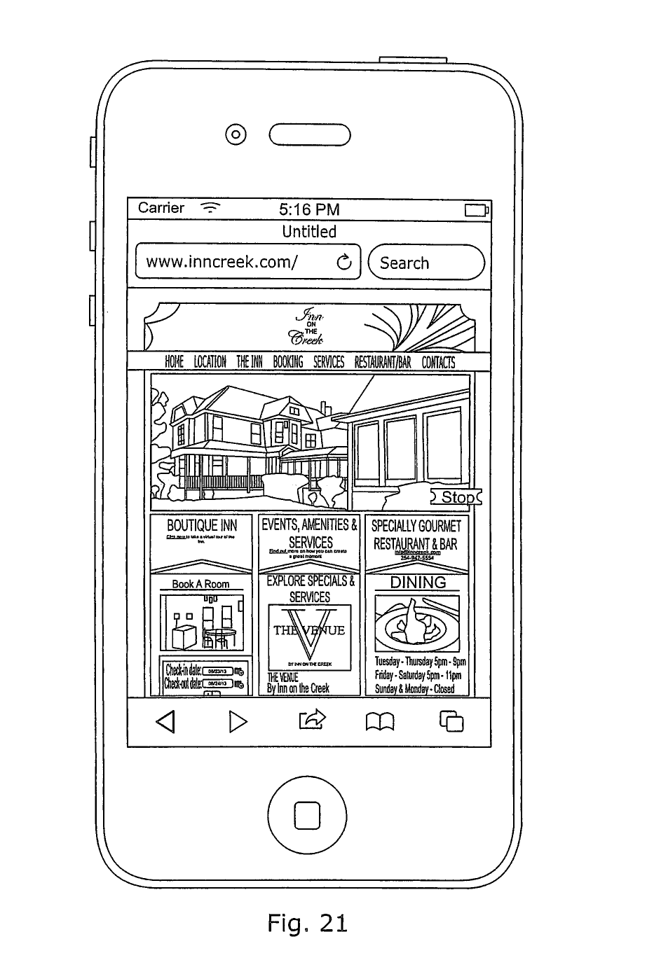

Referring to FIG. 21 herein, there is shown one example of a service providers webpage accessed by following a uniform resource locator (website) icon in a previous menu shown in FIG. 19 herein.

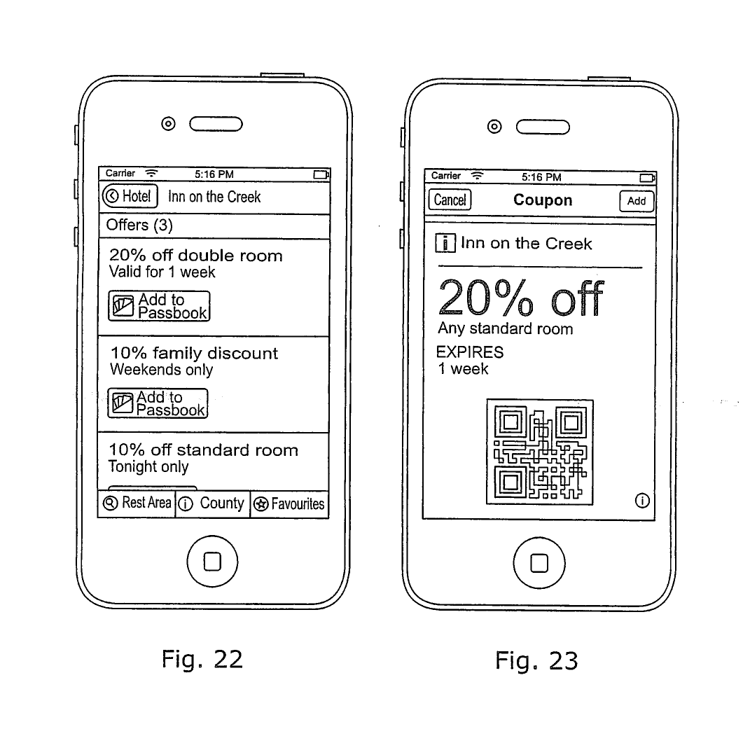

Referring to FIG. 22 herein, there is shown a sub-menu display corresponding to data received from the host computer, by following a sub-menu “Offers” as shown from the display in FIG. 19 herein.

Referring to FIG. 23 herein, by selecting a specific offer as shown in FIG. 22 herein, a traveller service provider can provide free service coupons or discounts which can be stored on the mobile telecommunications device and redeemed at the point of purchase when the user arrives at the service provider location.

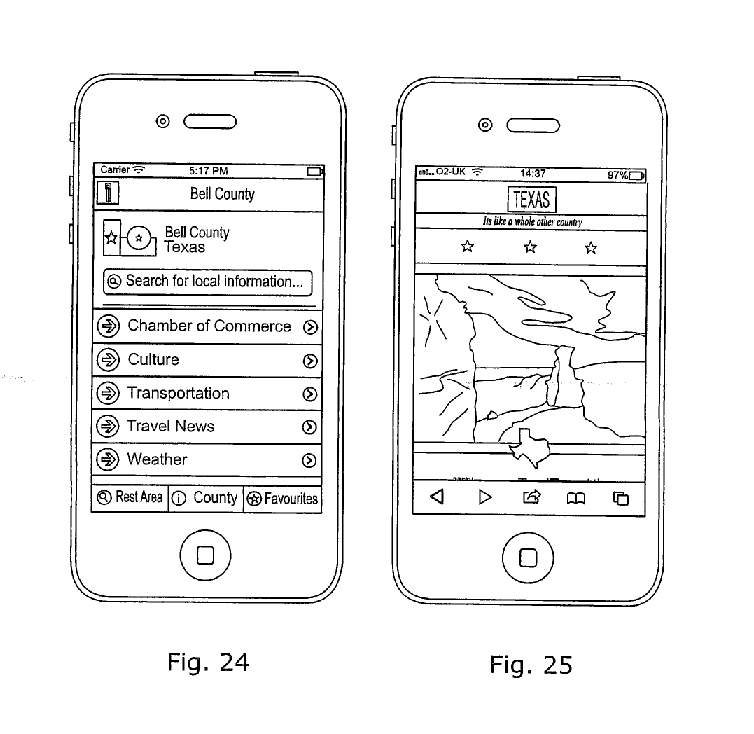

Referring to FIG. 24 herein, there is shown schematically a menu corresponding to information relevant to a general geographical location at which the quick response code is located (in this case Bellcounty, Tex.). General information in the immediately surrounding area of the quick response code location is available, such information including for example chamber of commerce information, local culture information, transportation information, travel news, weather and like information.

Referring to FIG. 25 herein, there is illustrated schematically a display accessed from the menu of FIG. 24 herein which takes the mobile telecommunications device user to a webpage or website operated by for example, a tourist bureau of the area in which the quick response code is located. The uniform resource locator for that webpage is provided by the host computer from data corresponding to the quick response code location.

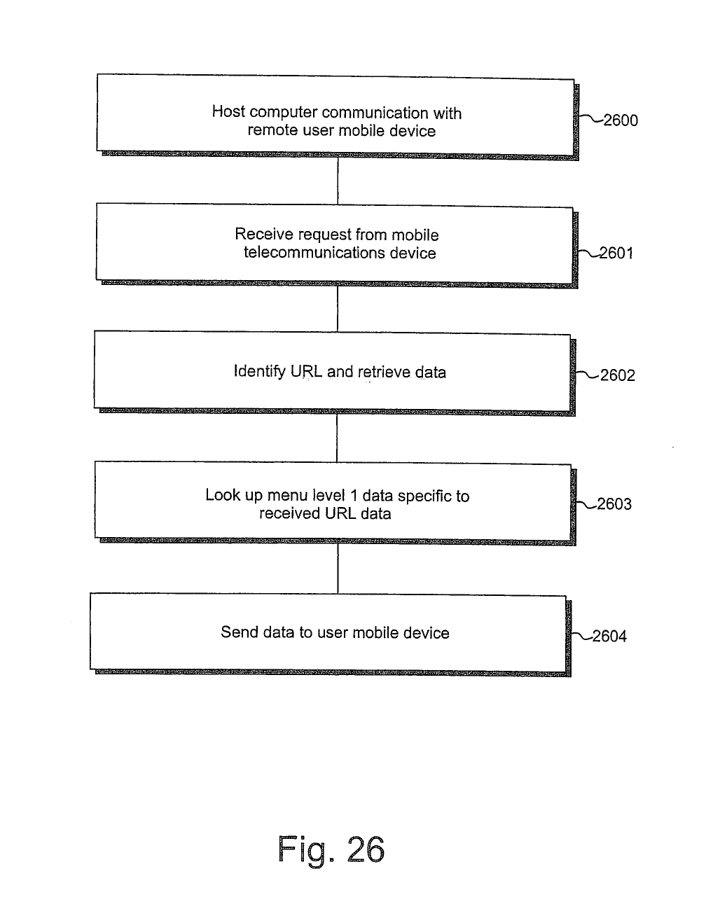

Referring FIG. 26 herein, there is illustrated schematically process steps carried out by the host server computer for providing data to a remote mobile telecommunications device.

At 2601, the host server computer receives a data request over the communications network addressed to a uniform resource locator.

At 2602, the host server computer in response identifies the uniform resource locator and retrieves data corresponding to the uniform resource locator.

At 2603, the host server computer looks up top level menu data specific to the received uniform resource locator data, and therefore specific to the location at which the quick response code is situated.

At 2604, the host computer sends traveller service data to the user's mobile telecommunications device, the traveller service data being specific to service providers associated with the geographical location at which the quick response code is situated.

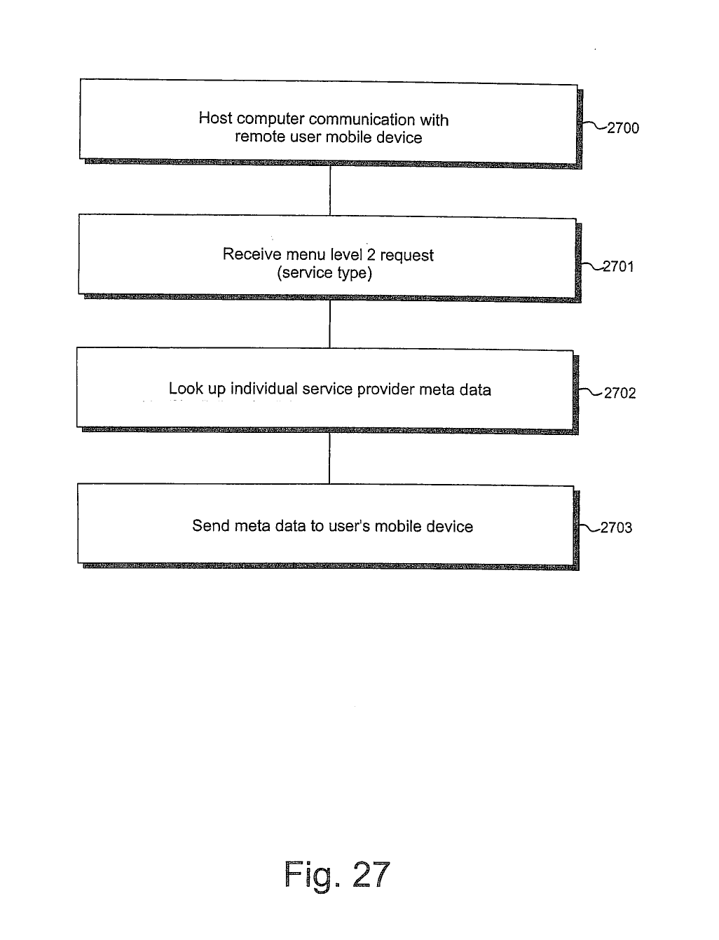

Referring to FIG. 27 herein, there is illustrated schematically processes carried out at the host computer to communicate with the user's mobile telecommunications device for provision of level 2 data concerning traveller services.

At 2701, the host computer receives a request for level 2 menu information (for example service type).

At 2702, the host computer looks up in its database data describing individual service providers, and their meta-data being data which describe general attributes of each service provider.

At 2703, the host computer sends the meta-data to the user's mobile telecommunications device, enabling the user's mobile telecommunications device to construct a display showing the meta-data, in a form which can be selected by a user.

The individual service provider meta data comprises data as shown in FIGS. 18-20 herein.

Traveller Service Provider Accounts and Traveller Service Provider Data Sessions

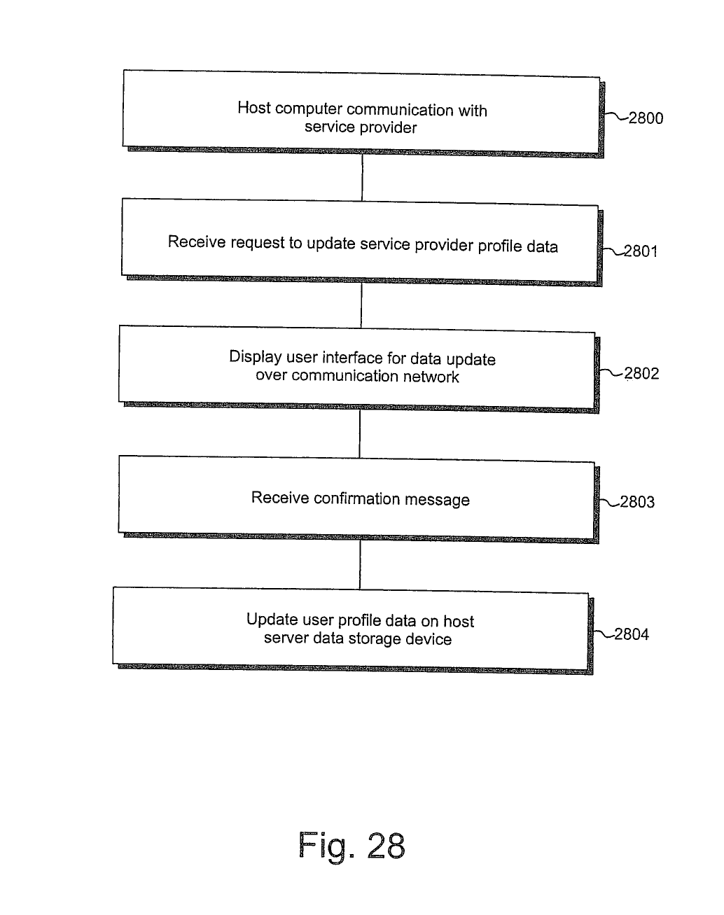

Referring to FIG. 28 herein, there is illustrated schematically broad overview process steps carried out by the host computer for communicating with one or a plurality of service provider computers to update the traveller service provider's data stored in the system. The host computer can communicate with more than one service provider computer at the same time. Each service provider computer has an account with the computer, enabling it to access its own set of data, and to modify that set of data during a service provider session.

Each traveller service provider can update details of their contact details, the service type, facilities and optionally information such as room availability, parking space availability, or any special offers or discounts to be stored on the host computer as part of the host computers service. These details may also be updated on the service providers own corporate website which can be linked through from the data provided by the host service, but the traveller service provider has the option of updating that information on the host service, so that a user does not need to click through to their full website to see details of special offers, room availability and facilities.

Further, if the traveller service changes their website address, or any other contact details, these details can be changed by the service provider logging in to a user interface provided on the host computer which enables them to change these details.

At 2801, the host computer receives a request from a service provider computer to update a service provider's profile data in the data storage device of the host computer.

At 2802, the host computer accesses the profile data of the particular service provider requesting a change of data, and sends that data to the service provider computer. The service provider computer can display that data on a display device at the service provider computer and can change the data.

At 2803, having changed data at the service provider computer, the service provider computer sends the modified data back to the host computer. The host computer receives the modified service provider data together with a confirmation message that the data is to be changed within the host computer's database.

At 2804, the host computer updates the user profile data of the service provider, in the data storage device of the host computer, in a location which is specifically assigned to a particular geographical location at which a quick response code marker is positioned at a highway service area as described herein before.

The communication method and apparatus herein, may provide a state Department of Transport with a unique approach to provide an income generator to offset some of the operating costs of maintaining Interstate rest areas and provide the traveller with information where they can eat, fuel and sleep as well as providing road, weather and tourist information off the nearest exit from that rest area.

The present described embodiments may:
provide data which meets all the needs of the traveller
met all Federal and State laws
provide an income generator for the state Department of Transport's to offset against the maintenance costs of the rest areas
provide support for local businesses, tourism and help the economic development of the area which the rest area serves

The present disclosed apparatus and methods may help fund the cost of maintaining the rest areas and improve the experiences of the traveller by providing information on accommodation, food, gas, local services and up to date travel information. The rest area stops are important to the traveller to avoid fatigue and tiredness which can lead to accidents. This facility should also provide important information on much needed services which will improve the economic development and tourist opportunities for many towns.

The benefits of the system described herein may include:
Supports local businesses and tourist centres
Offers the traveller better information on where to fuel, eat, stay, where to visit, travel information, weather conditions and access to import services such as police, hospitals, fire stations etc.
Generates revenue for the state Department of Transport to offset maintenance costs
The quick response codes sign is unobtrusive, does not need to be replaced (only after fair wear and tear), easily installed, and requires a minimum of maintenance.

Offers and Coupons

Stored on the host computer database, is a dataset for each traveller service, which identifies offers and coupons available from that service.

Upon accessing by a user, a coupon can be downloaded onto the users mobile telecommunications device, from the host server, or directly from the service providers website. Therefore, the offers and coupons are managed by the advertiser (service provider) rather than by the host service provider.

From a user's point of view, once they have gone to the top level page provided by the host computer, listing for example hotels, then can then identify a particular hotel from that holding page which takes the user to another page giving details about that particular hotel. One of the menu options on that hotel page is a coupon/discount page, which can detail the coupons or discounts provided by that hotel. All these pages are provided without re-routing the user to the hotel's own website, although there is also a uniform resource locator link on the hotel page, which can be followed to link the user to the hotel user's own website. To update the coupons and offers on the coupons page for that particular hotel user, the hotel operator can log in to their service provider account, and update or change any of the offers or coupons on the data on the host computer as described herein above. The service provider can upload their own coupons webpage onto the host server, so it is accessible by the user on the host computer.

Host Service Provider Website

Whilst the above information can be accessed at individual locations by reading a quick response code, the user can also go directly to a host service providers own website, which will list on, for example a particular highway, all of the rest stops on that highway, and for each rest stop, will list the same information as accessible by reading a quick response code. Therefore, users can plan in advance for their journey, and whilst on the journey can check at each rest stop the current status of service provider data, detailing for example current availability of rooms or current availability of parking spaces and current discounts on offer at the time of travel. Hence, the host server can provide the information by a conventional website, or on a stop by stop basis by reading individual quick response codes.

In this specification, where the term host server computer, or host server computer platform is used, although one example of a particular computer is given in the figures herein, the term encompasses a distributed computer or computers providing the same function including the general elements of data processing, data storage, communications interface and user interface, so that the host computer platform can be a distributed platform, or can comprise a single discrete physical computer.

Referring to FIG. 29 herein, overall implementation and use of the system to direct users to a set of traveller services associated with a first localised geographical area, involves providing (2900) a quick response code at a first geographical location, such as a highway rest area, truck stop or similar; using a handheld communications device, for example a mobile phone, tablet or the like to optically read (2901) the quick response code; the communications device connecting (2902) with a mobile telecommunications network to connect the communications device with a remote computer using a uniform resource locator (URL); the remote computer selecting (2903) pre stored data corresponding to the uniform resource locator, which has been obtained from the quick response code, wherein the pre stored data comprises data specific to a set of traveller services, comprising services of interest to a traveller, such as hotels, filling stations, shops, restaurants, rest rooms, visitor attractions, theme parks, leisure facilities, sites of historical or tourist interest or the like; wherein the traveller services are located at one or more second locations remote from said first location, for example a next highway or motorway turnout; and the remote computer sending (2904) the traveller service data to the mobile telecommunications device which read the quick response code.

In an optional variation, instead of sending the traveller data back to the communications device which read the QR code, the data may be served to a different destination device, such as an internet, terrestrial wireless, or satellite wireless connected vehicle navigation system on board a car, bus, truck or similar vehicle.

Referring to FIG. 30 herein, there is summarized in overview the process steps carried out at the server computer platform process to deliver traveler data to a set of users located at a first geographical location with traveller service data referring to services provided at a second location, but associated with the first location. The computer platform operates to receive a request associated with said quick response code located at a first geographical location (3000); store a set of data describing a plurality of services provided at a set of second geographical locations associated with said first geographical location (3001); associate said set of data describing a plurality of different services with said request (3002); and send (3003) said data describing a plurality of different services over said mobile phone communications network to a sender of said request.

1. A communications method for directing users to a set of traveller services associated with a first localised geographical area, said method comprising:
providing a quick response code at a first geographical location;
reading said quick response code using a mobile telecommunications device capable of connecting with a mobile telecommunications network;
linking said mobile telecommunications device to a remote server computer using a uniform resource locator (URL);
said remote server computer selecting data corresponding to said uniform resource locator, said data comprising data specific to said set of traveller services;
wherein said traveller services are located at one or more second locations remote from said first location; and
sending said traveller service data to said mobile telecommunications device.

2. The method as claimed in claim 1, wherein said quick response code is physically located at a first geographical location adjacent a highway; and
said set of traveller services comprises at least one service located at a second geographical location, which is remote from said first geographical location at which said quick response code is located and which is accessible via an immediate next highway turnoff from said first geographical location.

3. The method as claimed in claim 1, wherein said set of services data corresponding to said uniform resource locator comprises geographical location data corresponding to each of a plurality of traveller services.

4. The method as claimed in claim 1, wherein said selected data comprises at least one uniform resource locator of at least one said traveller service.

5. The method as claimed in claim 1, wherein said data specific to said set of traveller services comprises data identifying at least one service type.

6. The method as claimed in claim 1, wherein said traveller service data comprises data describing an availability of at least one corresponding said service.

7. The method as claimed in claim 1, wherein said set of data specific to said travel services comprises data describing one or more second locations.

8. The method as claimed in claim 1, wherein said set of data specific to said traveller services comprises data describing a direction, relative to said first geographical location, of a said one or more second locations.

9. The method as claimed in claim 1, wherein said data specific to said set of traveller services comprises electronic coupon data.

10. An apparatus for assigning services to a quick response code marker over a mobile telephone communications network, said apparatus comprising:
means for receiving a request associated with said quick response code located at a first geographical location;
means for storing a set of data describing a plurality of services provided at a set of second geographical locations associated with said first geographical location;
means for associating said set of data describing a plurality of different services with said request; and
means for sending said data describing a plurality of different services over said mobile phone communications network to a sender of said request.

11. A computer platform configured for:
receiving a request associated with said quick response code located at a first geographical location;
storing a set of data describing a plurality of services provided at a set of second geographical locations associated with said first geographical location;
associating said set of data describing a plurality of different services with said request; and
sending said data describing a plurality of different services over said mobile phone communications network to a sender of said request.

12. Computer program control instructions for controlling a computer platform for configured for:
reading a quick response code to find a uniform resource locator, wherein said uniform resource locator is uniquely associated with said quick response code;
connecting a mobile communications device to an address specified in said uniform resource locator;
selecting a set of data corresponding to said uniform resource locator; and
sending said selected set of data to said mobile communications device.

13. The computer program control instructions as claimed in claim 12, further configured for
displaying said selected data on a display of said mobile telecommunications device.

14. The instructions as claimed in claim 12, wherein said selected data set comprises data describing a service selected from the following set;
a local amenity service;
a filling station service;
a retailer service;
a tourist attraction;
a hotel service;
a restaurant service;
a camp site service;
a truck stop service.

15. The instructions as claimed in claim 12, wherein set of data describing a plurality of services is assigned to a single top level webpage, sent over said mobile telecommunications network.

16. The instructions as claimed in claim 12, wherein each of a plurality of service providers are assigned one or a plurality of webpages, for containing a set of data specific to said service provider.

17. The instructions as claimed in claim 12, wherein a said set of data corresponding to a uniform resource locator comprises an electronic coupon.

18. A computer platform apparatus configured for communicating with a mobile telecommunications device, to provide data specific to a set of services associated with a first geographical location at which said mobile communications device is located said services being located at a set of second geographical locations, said apparatus comprising:
a central processing unit;
at least one memory;
at least one communications interface;
wherein said computer platform apparatus is configured for:
receiving a uniform resource locator corresponding to a quick response code data;
identifying said uniform resource locator;
identifying data assigned to said uniform resource locator, said data describing a said set of services located at a set of second geographical locations; and
sending said service data to said mobile communications device.

19. A method of using a quick response (QR) code on printed matter to advertise a uniform resource locator (URL) said method characterised by:
receiving a said uniform resource locator;
in response to said received uniform resource locator, reading a database of goods and services geographically relevant to a physical site of said quick response code location.

20. The method as claimed in claim 19, comprising, reading directions to the location of said goods and services.

21. The method as claimed in claim 19, comprising the steps of:
determining a long uniform resource locator;
creating a short uniform resource locator based on the long uniform resource locator;
including the short uniform resource locator within a quick response code;
utilizing the quick response code on printed matter,
whereby scanning of the quick response code by a mobile phone with a suitable reader and internet connectivity redirects the mobile phone device to a location specific uniform resource locator web page.

22. The method as claimed in claim 19, wherein the printed matter is a floor graphic or a poster.

23. The method as claimed in claim 19, wherein the printed matter may be located at but not limited to: a rest area, a picnic spot, a recreational site or an area where limited advertising space is available.

24. The method as claimed in claim 19, wherein the mobile phone device may be another device capable of reading the quick response code and accessing the uniform resource locator web page.

25. The method as claimed in claim 19, whereby the menu of goods and services include but are not limited to: local hotel facilities, restaurants, gas stations, tourist information and weather information.

26. The method as claimed in claim 19, wherein the uniform resource locator web page may permit direct access to the specific uniform resource locator pages of any of the goods and services advertised.

27. The method as claimed in claim 19, which via the geographically relevant uniform resource locator provides links to coupons or vouchers relative to the goods and services provided in that locality.

28. The method as claimed in claim 19, further comprising providing a multitude of individual holding pages, each specific to the goods or services being advertised.

29. A method as claimed in claim 19, further comprising providing a multitude of individual holding pages, wherein each said holding page can be directly modified by a service provider.
